(19) United States
(12) Patent Application Publication
(10) Pub. No.: US 2008/0214678 A1
(43) Pub. Date: Sep. 4, 2008

(54) Biopesticide Comprising a Composition Rich in Diallyl Polysulphides

(76) Inventors: David Gaudout, Romagne (FR); Claude Inisan, Rennes (FR); Serge Durechou, La Croisille (FR); Denis Megard, St. Brico en Cogles (FR)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/582,043

(22) PCT Filed: Dec. 9, 2004
(86) PCT No.: PCT/FR04/03173

§ 371 Date: Mar. 17, 2008

(30) Foreign Application Priority Data
Dec. 9, 2003 (FR) 0314394

(51) Int. Cl. A01N 41/12; A01P 7/04

(52) U.S. Cl. 514/707

(57) ABSTRACT

The present invention relates to compounds based on diallyl polysulfides, and to biopesticides comprising said compositions. The invention also relates to the use of biopesticides based on said compositions rich in diallyl polysulfides for the effective insecticidal activity thereof in relation to a large number of insects.

The invention further relates to a method of producing said compositions.

The present invention relates to compositions based on diallyl polysulfides and to biopesticides comprising these compositions. The invention also relates to the use of biopesticides based on these compositions rich in diallyl polysulfides for the effective insecticidal activity thereof in relation to a large number of insects.

The invention also relates to the method of producing these compositions.

Since the earliest times, the secondary compounds of plants have been reputed for their pharmacological properties and for decades, man has been interested in their biological properties.

Among these plants, garlic is one of the most commonly studied and the most commonly used for its various antibacterial and antifungal properties, but also for its positive action in decreasing cholesterol, inhibiting platelet aggregation or improving fibrinolytic activity (Monograph on garlic, Commission E—1998).

This diversity of activity is directly related to the diversity of the sulfur-containing (active) molecules which are obtained during the constitution and degradation of precursor molecules such as γ-glutamylcysteine and alliin (molecules that are found in garlic). The antibacterial action observed is, for example, related to the allicin derived from the enzymatic conversion of alliin (Cavallito et al., 1944).

The advantage, in plant-protection terms, of sulfur-containing molecules, more particularly those of garlic, has also been studied (Auger 2001). Cases of anti-appetence and repellent effects have been observed, for example, on Epilachna varivestis, where extracts of garlic significantly reduce the rate of egg laying of females of the pear psyllid Cacopsylla pyricola (Weissling et al. 1997).

Furthermore, various orders of insects are sensitive to the insecticidal effects of alliums. This is the case of the greenhouse whitefly Bemisia argentifolii, the eggs, nymphs and adults of which are sensitive to the presence of various extracts of garlic (Flint et al. 1995).

Auger et al. have shown that insects subjected to fumigation do not all exhibit the same sensitivity to sulfur-containing molecules. They have calculated LC50 lethal concentrations (concentration, expressed in mg of product/L air, for which 50% of the insects are killed after 24 h of treatment) on pure molecules present in garlic: diallyl disulfide (DAS2), dimethyl disulfide (DMS2), dipropyl disulfide (DPS2), dimethyl thiosulfinate (TiM2), allicin (TiA2) (Auger et al. 2002, 2001; Huignard et al. 1999). The LC50 values vary as a function of the insects tested, but also as a function of the developmental stage of the insect (an adult is generally more sensitive than a larva, which is itself more sensitive than the egg).

Patent EP 0 843 965 describes a pesticidal emulsion containing an emulsifier optionally associated with extracts of garlic. However, it is only noted that the extract of garlic is obtained by extraction, using an organic solvent, from fresh cloves, and the composition of the extracts used is not described.

Patent EP 0 945 066 describes a composition for pesticidal, insecticidal and/or fungicidal purposes, comprising an extract or an oil of garlic as a mixture with another active ingredient (essential oil, plant, mineral or animal oil, etc.). No precise composition of the extracts of garlic used is, however, described.

Despite the plant-protection advantage of garlic, all the known commercial garlic-based products (for example, Garlic Barrier, Organomex Gard-S) are recommended as repellent agents or as growth stimulators. No product is to date sold as an insecticide. The complexity of garlic chemistry, related to the analytical and industrial difficulties for obtaining standardized extracts of garlic having a perfectly defined and reproducible composition, explains why no commercial product with a clearly established composition is available on the current market as a biopesticide.

The applicant has discovered a specific and well-defined chemical composition having effective insecticidal activity in relation to a large number of insects and corresponding to the normal conditions of use in an agricultural medium (satisfactory storage stability at ambient temperature).

The applicant has thus developed biopesticides comprising a composition characterized by a defined content of diallyl polysulfides, which constitutes the subject of the invention.

Another subject of the invention consists of the use of these biopesticides for controlling pests of agricultural products and foodstuffs and also wood and textile pests.

Another subject of the invention consists of the use of these biopesticides for controlling human and animal infestation with sucking insects.

Another subject of the invention consists of the method of producing a composition comprising these characteristics.

Another subject of the invention consists of compositions characterized by a defined content of diallyl polysulfides and the presence of γ-glutamyl-S-allylcysteine.

Other subjects emerge on reading the description and the examples which follow.

A subject of the present invention is biopesticides comprising, inter alia, a composition characterized in that it contains diallyl sulfide (DAS), diallyl disulfide (DAS2), diallyl trisulfide (DAS3) and diallyl tetrasulfide (DAS4), the sum by weight of which is equivalent at least to one milligram per gram of composition.

The term “DAS” is intended to mean diallyl sulfide, the term “DAS2” is intended to mean diallyl disulfide, the term “DAS3” is intended to mean diallyl trisulfide, and the term “DAS4” is intended to mean diallyl tetrasulfide.

Preferably, at least 50% of the DASn consist of DAS2 and DAS3. The term “DASn” :is intended to mean diallyl polysulfides.

The biopesticides comprising the composition according to the invention can comprise an extract of garlic. The composition included in the biopesticides according to the invention can also comprise Gluacs (γ-glutamyl-s-allylcysteine), allicin or alliin.

The composition according to the invention can be devoid of allicin and/or of alliin.

Preferably, in this extract of garlic, the sulfur-containing compounds are predominant. The term “sulfur-containing compounds” is intended to mean diallyl polysulfides (DASn), allyl methyl polysulfides (AMSn), dimethyl polysulfides (DMSn), including dimethyl disulfide (DMS2), allyl propyl polysulfides (APSn), methyl propyl polysulfides (MPSn), dipropyl polysulfides (DPSn) including dipropyl disulfide (DPS2), dimethyl thiosulfinate (TiM2) and allicin (TiA2).

Preferably, the DASn represent more than 50% of the sulfur-containing compounds of the extract of garlic.

A subject of the present invention is also a composition characterized in that it contains diallyl sulfide (DAS), diallyl disulfide (DAS2), diallyl trisulfide (DAS3) and diallyl tetrasulfide (DAS4), the sum by weight of which is equivalent at least to one milligram per gram of composition, and Gluacs.

This composition can also comprise allicin or alliin.

The composition according to the invention can be devoid of allicin and/or of alliin.

The biopesticide according to the invention can also comprise formulation adjuvants, such as various oils, emulsifiers and solvents that can, for example, facilitate the application and improve the effectiveness of the biopesticide through better attachment to the leaves.

Examples of adjuvants are plant oils, propylene glycol, and thickeners, for instance maltodextrin.

Examples of emulsifiers include lecithin or sugar esters. Examples of solvents are alcohols, and in particular ethanol, ketones, and in particular methyl ethyl ketone, and ethers, including diethyl ether.

A subject of the invention is also the use of the biopesticide for controlling pests of agricultural products and foodstuffs, and wood and textile pests. This biopesticide can also be used for controlling human and animal infestation with lice or other sucking insects.

The compositions rich in DASn described in the invention can be obtained by means of the following method of production, which allows the selective production of a compound containing DAS, DAS2, DAS3 and DAS4, the sum by weight of which is equivalent at least to one milligram per gram of composition, from garlic.

The extracts of garlic used in the composition according to the invention are obtained by aqueous extraction from fresh garlics.

The method of producing such a composition consists in
milling the fresh garlics under hot conditions,
recovering the volatile fractions,
pressing the milled material in the presence or absence of water at a temperature of between 10 and 60° C.,
filtering the garlic juice,
concentrating it under vacuum at low temperature (T≦60° C.) until an appropriate concentration, generally of between 30 and 75 degrees Brix, is obtained. The degree Brix, the measurement of which is carried out using a refractometer, is the weight in grams of solids contained in 100 grams of product,
recovering the volatile fractions and reintroducing them into the extracts so as to produce the composition which is the subject of the present invention.

In certain cases, the enzymatic activity of the garlic (in particular that related to alliinase) is inhibited by means of an appropriate thermal treatment applied before the extraction. An acidification also makes it possible to inhibit the enzymatic activity. It is also possible to use sulfites so as to prevent oxidation phenomena during the milling as the method occurs.

The various extraction conditions are controlled in order to produce compounds based on extracts of garlic exhibiting profiles of sulfur-containing compounds and chemical compositions that are different, in particular profiles of γ-glutamyl-S-allylcysteine (Gluacs), of allicin (TiA2) and of diallyl polysulfides (DASn).

Variants in the method of producing the composition according to the invention, described above, resulted in compositions numbered “extract 00” to “extract 05”.

The following examples illustrate the invention without in any way limiting it.

### EXAMPLE 1

### Compositions According to the Invention and Molecules Used in Comparison

The known garlic-based commercial products do not, strictly speaking, claim pesticidal properties. They are sold as repellent agents or growth stimulators. Among these, the applicant selected Organomex Gard-S, Garlic Barrier and Garvitan. Two reference molecules, DAS2 (Aldrich) and allicin (TiA2 purified by Mr Auger, University of Tours), are also used in comparison.

The composition of the extracts is determined by HPLC on a SpherisorbODS2 column (5 μm 4.6×250 mm) equipped with a 10 mm precolumn packed with the same stationary phase. The elution gradient is determined according to the studies of Knoblock and Lawson (Knobloch et al. (1990) Planta. med. 56, 202-211, Lawson et al. (1991) Planta Med. 57, 363-370).

A typical chromatogram is: presented in the attached figure (FIG. 1) and the composition of the various extracts is summarized in the table below, the composition of the various molecules being expressed in mg/g of extract.

| Extract | Gluacs | Alliin | Allicin | DAS | DAS2 | DAS3 | DAS4 | DASn |
|---|---|---|---|---|---|---|---|---|
| Extract 00 | 1.250 | 7.550 | 0 | 0 | 0 | 0 | 0 | 0 |
| Extract 01 | 6.854 | 0 | 0.000 | 0.741 | 1.898 | 6.033 | 1.375 | 10.047 |
| Extract 02 | 7.027 | 0 | 0.000 | 0.957 | 3.964 | 10.178 | 1.473 | 16.572 |
| Extract 03 | 5.870 | 0 | 0.000 | 0.024 | 0.134 | 0.781 | 0.226 | 1.165 |
| Extract 04 | 0.000 | 0 | 0.000 | 0.902 | 3.737 | 9.595 | 1.389 | 15.622 |
| Extract 05 | 0.000 | 0 | 0.391 | 0.009 | 0.023 | 0.073 | 0.000 | 0.105 |
| Garlic Barrier | 0.000 | 0 | 0.000 | 0.003 | 0.007 | 0.010 | 0.002 | 0.022 |
| Organomex | 4.501 | 0 | 0.000 | 0.011 | 0.025 | 0.202 | 0.055 | 0.293 |
| Gard-S | | | | | | | | |
| Garvitan | 0.000 | 0 | 0.146 | 0.000 | 0.000 | 0.000 | 0.000 | 0.000 |

DASn = sum of the concentrations of [DAS + DAS2 + DAS3 + DAS4]

The commercial products are, depending on the sulfur-containing molecule under consideration, between 2 and 1000 times less rich in sulfur-containing compounds than the extracts 01 to 04 that form the subject of the present application.

### EXAMPLE 2

### Pesticidal Activity in a Closed Space of Extracts 01 to 04

The pesticidal activity of the extracts is measured in a closed space on adult insects. Each value represents the mean of three experiments, each involving 30 insects representative of three different insect orders:
lepidoptera (the clothes moth Tineola bisselliella),
isoptera (the Saintonge termite Reticulitermes santonensis), and
coleoptera (the bean weevil Callosobruchus maculatus)

The measured LC50 corresponds to the concentration, expressed in mg of product/liter of air, for which 50% of the insects are killed after 24 h of treatment.

The results, represented on the attached histogram (FIG. 2), are summarized in the table below:

| | Mite | Termite | Weevil |
|---|---|---|---|
| Extract | LC50 (mg/l) | LC50 (mg/l) | LC50 (mg/l) |
| Extract 01 | 1.62 | 1.3 | 24.96 |
| Extract 02 | 1.36 | 1.83 | 24.82 |
| Extract 03 | 2.43 | 1.8 | 25.96 |
| Extract 04 | 1.52 | 2.12 | 17.82 |
| Extract 05 | 13.20 | 12.34 | NM |
| Garlic Barrier | 67.4 | 370.12 | 242.82 |
| Organomex Gard-S | 50.65 | 92.04 | NQ |
| Garvitan | 23.32 | 24.29 | NQ |
| DAS2 | 0.02 | NM | 0.5 |
| TiA2 | NM | NM | 0.16 |

NM = not measured
NQ = non-quantifiable due to the absence of activity

Thus, the extracts of garlic 01 to 04 and the reference molecules (DAS2 and TiA2) tested show an insecticidal activity, the reference molecules exhibiting the greatest efficiencies.

The extracts of garlic according to the invention are very effective on the three types of insects tested, with LC50 values of between 1.4 and 2.4 mg/l for the mite, between 1.3 and 2.1 mg/l for the termite, and between 18.0 and 25.0 mg/l for the weevil. These insect species are representative of pests of economic interest, the termite being prejudicial to timber, the weevil being a pest of stored foodstuffs and the mite being prejudicial to clothes and to textiles.

The commercial products tested, Garlic Barrier, Organomex Gard-S and Garvitan, all show activities that are very clearly lower than the extracts that form the subject of the present application. Garlic Barrier, the only one effective on the 3 insects tested, shows an effectiveness between 10 and 285 times lower than extracts 01 to 04.

The compounds Organomex Gard S and Garvitan are not effective on the weevil, which may be explained by a greater resistance of this coleoptera to plant-protection treatments in general.

### EXAMPLE 3

### Relationships Between Pesticidal Effectiveness and Chemical Composition

The extracts rich in DASn showed a high pesticidal activity, much higher than the extract containing allicin. Now, numerous articles show that allicin is the most toxic compound for most insects, and that the toxicity of the molecules from the most toxic to the least toxic, is: Ti2 (allicin)≧TiM2 (dimethyl thiosulfinate)>DMS2 (dimethyl disulfide)>DAS2>DPS2 (dipropyl disulfide) (Auger and Thibout, 2001; Auger et al., 2002; Auger et al., 1999). It is generally acknowledged that Tis (thiosulfinates) are 10 to 100 times more toxic than DSs (disulfides).

Although there are only a very few studies describing the pesticidal effect of DASn, the effectiveness of the extracts that form the subject of the application can be associated with their richness in DAS3, DAS3 being known to be more toxic than DAS2 (Nammour et al., 1989).

It is also possible, to a certain extent, to correlate the biopesticidal activity of the extracts according to the invention with the DASn content. Thus, starting from the activity of the reference DAS2 on mites and weevils, it is possible to calculate the theoretical biopesticidal activity that will be obtained by comparing the total DASn concentration of the extracts with DAS2. This test was not carried out on termites.

The DAS2 activities are 0.02 mg per liter and 0.5 mg per liter, so as to obtain the LC50, respectively, on the mite and the weevil (see table of Example 2). Extract 01, for example, contains 10.047 mg of DASn per gram of extract (determined in Example 1). If this amount of DASn is compared with DAS2, then 1.99 mg of extract would be necessary to obtain an LC50 identical is to that obtained with the reference DAS2. Now, the values observed show that 1.62 mg of extract 01 per liter is sufficient to attain the LC50.

The other values in the table are calculated on the same principle.

| | Mite | Mite | Weevil | Weevil |
|---|---|---|---|---|
| | LC50 (mg/l) | LC50 (mg/l) | LC50 (mg/l) | LC50 (mg/l) |
| Extract | calculated | observed | calculated | observed |
| Extract 01 | 1.99 | 1.62 | 49.77 | 24.96 |
| Extract 02 | 1.21 | 1.36 | 30.17 | 24.82 |
| Extract 03 | 17.17 | 2.43 | 429.18 | 25.96 |
| Extract 04 | 1.28 | 1.52 | 32.01 | 17.82 |
| Garlic Barrier | 909 | 67.4 | 22757 | 242.82 |
| Organomex | 68 | 50.65 | 1706.5 | NQ |
| Gard-S | | | | |
| DAS2 | 0.02 | 0.02 | 0.5 | 0.5 |

As a general rule, it is noted that the activity observed (inverse of the LC50) is slightly greater than the calculated activity, which confirms the greater effectiveness of the DAS3s, or even DAS4s, compared with that of the DAS2. The lower the total content of DASn, as in the case of extract 03 for example, the truer this is. A high DAS3 content is therefore advantageous in terms of the biopesticidal effectiveness of the extract according to the invention.

The products, on the market, Garlic Barrier and Organomex Gard S contain too little DASn to show a satisfactory effectiveness, and a threshold effect is even observed since the Organomex does not act on the weevil whatever its dosage.

Garvitan or extract 05, relatively rich in allicin, exhibits a low activity. The main drawback of this product is the low stability of allicin at ambient temperature (storage conditions commonly used in agriculture). The Garvitan supplier recommends storage of this extract at +4° C. with a UBD (optimal use-by date) of 6 months.

In conclusion, the products: available on the market are not sold as pesticides. They are depleted of allicin and of DASn, and in any case, too depleted to show a satisfactory activity.

### EXAMPLE 4

### Pesticidal Activity on Whitefly by Spraying

The repellent and lethal activity of extract 01 with respect to Trialeurodes vaporarium whitefly (adults provided by the company Biobest) is measured on tomato plants 15 cm high in a Potter tower under controlled conditions (temperature 21° C., relative humidity 70%).

The larvae used are obtained by placing adults on untreated tomato plants.

The modes tested are as follows:

| Mode | Active product (L/ha) |
|---|---|
| Control (distilled water) | 0 |
| Extract of garlic 01 | 2 |
| Extract of garlic 01 | 3 |
| Extract of garlic 01 | 4 |
| Toxic reference: Applaud | 0.3 |
| (commercial product) | |

Each mode comprises 4 repetitions comprising 10 to 25 adults.

The various active products are diluted 50/50 in an appropriate diluent. The Applaud, a synthetic pesticide marketed by the company Calliope and used here as a reference, is not diluted since it is already ready-to-use. The repellent tests are carried out by spraying onto the leaves before introduction of the adults, the mortality tests are carried out after a single spray onto the leaves infested with whitefly.

The studies were carried out using a statistical program—ITCF (Institut Techniques des Céréales et Fourrages [Technical Institute of Cereals and Fodders] in Paris).

The results of the statistical analysis demonstrate the fact that extract 01 has a repellent effect on the females from the dose of 3 L/ha, bringing about a significant reduction in the fertility of the females one week after installation thereof:

| | Number of | Fertility | Homogeneous |
|---|---|---|---|
| | females (sum of | (average number | groups (Newman- |
| | the various | of eggs | Keuls test at a |
| Mode | repetitions) | laid/females) | 5% threshold) |
| Control | 100 | 22 | A |
| Extract 01 at | 67 | 15 | AB |
| 2 L/ha | | | |
| Extract 01 at | 190 | 11 | BC |
| 3 L/ha | | | |
| Extract 01 at | 115 | 6 | BC |
| 4 L/ha | | | |
| Applaud at | 42 | 14 | C |
| 0.3 L/ha | | | |

Extract 01, from the dose of 2 L/ha, also has a significant effect on the mortality of the young larvae. At the dose of 4 L/ha, the effectiveness is identical to that of Applaud at 0.3 L/ha:

| | Mortality | | Homogeneous |
|---|---|---|---|
| | measured | | groups (Newman- |
| | (% of dead larvae/ | Converted | Keuls test at a |
| Mode | total larvae) | mortality | 5% threshold) |
| Control | 0 | 0 | A |
| Extract 01 at | 26.6 | 27.0 | B |
| 2 L/ha | | | |
| Extract 01 at | 55.6 | 48.2 | BC |
| 3 L/ha | | | |
| Extract 01 at | 80.0 | 67.2 | C |
| 4 L/ha | | | |
| Applaud at | 78.4 | 67.7 | C |
| 0.3 L/ha | | | |

Extract 01 has an even greater effect on the oldest larvae (larvae at stage L3-L4). From the lowest dose (2 L/ha), the results obtained demonstrate an effectiveness that is comparable to, or even greater than, that of the reference:

| | Mortality | | Homogeneous |
|---|---|---|---|
| | measured | | groups (Newman- |
| | (% of dead larvae/ | Converted | Keuls test at a |
| Mode | total larvae) | mortality | 5% threshold) |
| Control | 0 | 0 | A |
| Extract 01 at | 92.8 | 73.8 | B |
| 2 L/ha | | | |
| Extract 01 at | 100 | 90.0 | C |
| 3 L/ha | | | |
| Extract 01 at | 98.6 | 85.4 | C |
| 4 L/ha | | | |
| Applaud at | 93.6 | 75.7 | B |
| 0.3 L/ha | | | |

The analysis of the mortality of the young larvae (analysis on 355 larvae) using a probit analysis program makes it possible to determine an LD50 (dose giving 50% mortality) for extract 01 of 2.64 L/ha, with a range of between 2.34 and 2.87 L/ha.

Extract 01 is therefore very active on the whitefly larvae, for which a dose-effect could be demonstrated. This extract is, moreover, more effective on the old larvae than on the young, with an effectiveness comparable to that of Applaud from 2 L/ha on the old larvae and from 4 L/ha on the young larvae.

### EXAMPLE 5

### Pesticidal Activity on Aphids

The same study as above is carried out at the same dosages on Rhopalosiphum padi cereal aphids, on wheat plants 15 cm high (15 to 50 aphids per mode and per trial).

The reference commercial product is Decis CE, a synthetic pesticide at a dose of 0.12 kg/ha.

| | | | Homogeneous |
|---|---|---|---|
| | Mortality | | groups (Newman- |
| | measured | Converted | Keuls test at a |
| Mode | (% of dead aphids) | mortality | 5% threshold) |
| Control | 2.44 | 7.25 | A |
| Extract 01 at | 4.34 | 8.06 | A |
| 2 L/ha | | | |
| Extract 01 at | 4.34 | 11.51 | A |
| 3 L/ha | | | |
| Extract 01 at | 12.14 | 20.96 | B |
| 4 L/ha | | | |
| Decis at | 92.18 | 74.06 | C |
| 0.12 kg/ha | | | |

Extract 01 is found to be active on the aphids, but at dosages much higher than the reference product.

### EXAMPLE 6

### Pesticidal Activity on Red Mite

The same study as that described in Example 4 is carried out at the same dosages on the red mite Panonychus ulmi placed in the test on apple tree leaves maintained under survival conditions on filter paper with a cotton strip, on the leafstalk. The area of exposure to the treatment products is delimited on the leaves using a barrier of glue.

The reference treatment product is Kelthane, a synthetic pesticide, at the dosage of 1 L/ha.

Test on adults:

| | Mortality on adult | Homogeneous groups |
|---|---|---|
| | acarids (% of dead | (Newman-Keuls test at |
| Mode | aphids) | a 5% threshold) |
| Control | 38 | A |
| Extract 01 at 2 L/ha | 100 | B |
| Extract 01 at 3 L/ha | 100 | B |
| Extract 01 at 4 L/ha | 100 | B |
| Kelthane at 1 L/ha | 100 | B |

N.B. the acarids that have become glued are not taken into account in the mortality.

The extract of garlic has a very positive effect on the mortality of the adult acarids, from the lowest dosage:

Tests on larvae:

| | | | Homogeneous |
|---|---|---|---|
| | Mortality of | | groups (Newman- |
| | young larvae (% | Converted | Keuls test at a |
| Mode | of dead aphids) | mortality | 5% threshold) |
| Control | 0 | 34.97 | A |
| Extract 01 at | 100 | 90 | B |
| 2 L/ha | | | |
| Extract 01 at | 100 | 90 | B |
| 3 L/ha | | | |
| Extract 01 at | 100 | 90 | B |
| 4 L/ha | | | |
| Kelthane at | 100 | 90 | B |
| 1 L/ha | | | |

Extract 01 also has a very substantial effect on the mortality of young larvae from the lowest dosage:

Thus, extract 01 according to the invention exhibits a very significant effect on the mortality, both on the adults and on the larvae of the red mite.

It is thus shown, in these various tests (Examples 4, 5 and 6), that the extract of garlic at the doses tested is as effective as the synthetic products which are the references on the market.

### EXAMPLE 7

### Pediculicidal Activity on Sucking Insects

The anti-lice activity of the extract of garlic 02 is measured in vitro. The lice used are the lice Pediculus humanus humanus raised in the laboratory and gorged on blood (breeding colony maintained on rabbits).

The lice are immersed, in batches of 5 individuals, in 300 μL of distilled water (control) or in 300 μL of the extract of garlic diluted to 50% W/W with water (so as to avoid having a sticky texture) in Eppendorf tubes. After manual shaking for 5 seconds, the content of each tube is poured onto a disk of filter paper 5 cm in diameter covering the bottom of a Petri dish. The dish is closed and conserved at ambient temperature. The number of live or dead lice is noted, for each dish, as a function of time.

The lice are fractionated into batches and each experiment is carried out on 5 lice. The experiment is repeated 10 times in order to carry out the measurement on a total of 50 lice for each condition. The results are as follows:

Percentage of dead lice
as a function of time

| | | Extract 02 diluted to 50% |
|---|---|---|
| Hours | Control | by weight |
| 0 | 0 | 0 |
| 1 | 0 | 12.0 |
| 2 | 0 | 12.0 |
| 3 | 0 | 12.0 |
| 4 | 0 | 16.0 |
| 5 | 0 | 18.0 |
| 6 | 0 | 18.0 |
| 7 | 0 | 18.0 |
| 8 | 0 | 20.0 |
| 9 | 0 | 24.0 |
| 10 | 3.0 | 38.0 |
| 24 | 7.0 | 74.0 |

Extract 02 shows a real pediculicidal activity, even though the contact time necessary between lice and extract is quite long.

### EXAMPLE 8

### Formulation of a Biopesticide According to the Invention for Controlling Coleoptera

The percentages of the various compounds are, by weight:
50% of extract of garlic containing 0.7 mg of DAS/g of extract; 1.8 mg of DAS2/g of extract; 5 mg of DAS3/g of extract and 1.3 mg of DAS4/g of extract,
45% of sunflower oil,
5% of sunflower lecithin.

This biopesticide formulation for controlling coleoptera is used in a greenhouse or in the open field at a rate of 20 kilograms of sprayed composition per hectare after dilution in water.

1. The use, as a biopesticide, of a composition comprising diallyl sulfide (DAS), diallyl disulfide (DAS2), diallyl trisulfide (DAS3) and diallyl tetrasulfide (DAS4), the sum by weight of which is at least one milligram per gram of composition.

2. The use as claimed in claim 1, for controlling pests of agricultural products and foodstuffs, and wood and textile pests.

3. The use as claimed in claim 1, for controlling human and animal infestation with lice or other sucking insects.

4. A biopesticide comprising a composition, characterized in that it contains diallyl sulfide (DAS), diallyl disulfide (DAS2), diallyl trisulfide (DAS3) and diallyl tetrasulfide (DAS4), the sum by weight of which is at least one milligram per gram of composition, and formulation adjuvants.

5. The biopesticide as claimed in claim 4, characterized in that at least 50% of the diallyl polysulfides (DASn) consists of DAS2 and DAS3.

6. The biopesticide as claimed in claim 4, characterized in that it comprises an extract of garlic.

7. A method of producing a composition containing DAS, DAS2, DAS3 and DAS4, the sum by weight of which is at least one milligram per gram of composition, comprising the steps consisting in milling the garlic under hot conditions and subsequently recovering the volatile fractions, then a step consisting in pressing the garlic followed by a step consisting in filtering the pressed garlic, and then a step consisting in concentrating under vacuum and subsequently recovering the volatile fractions.

8. The method as claimed in claim 7, comprising a step consisting in inhibiting the enzymatic activity of the garlic by means of an appropriate thermal treatment applied before the extraction.

9. The method as claimed in claim 7, comprising a step consisting in inhibiting the enzymatic activity of the garlic by means of an appropriate acidification.

10. The method as claimed in claim 7, comprising a step consisting in using sulfites so as to prevent oxidation phenomena.

11. A composition containing DAS, DAS2, DAS3, DAS4, the sum by weight of which is at least one milligram per gram of composition, and gamma-glutamyl-S-allylcysteine (Gluacs), characterized in that it can be produced by means of the method as defined in claim 7.

12. A composition, characterized in that it contains diallyl sulfide (DAS), diallyl disulfide (DAS2), diallyl trisulfide (DAS3) and diallyl tetrasulfide (DAS4), the sum by weight of which is at least one milligram per gram of composition, and in that it contains Gluacs.

13. The composition as claimed in claim 12, characterized in that at least 50% of the diallyl polysulfides (DASn) consists of DAS2 and DAS3.

14. The composition as claimed in claim 12, characterized in that it comprises and extract of garlic.

15. The composition as claimed in claim 14, characterized in that the sulfur-containing compounds consisting of diallyl polysulfides (DASn), allyl methyl polysulfides (AMSn), dimethyl polysulfides (DMSn), allyl propyl polysulfides (APSn), methyl propyl polysulfides (MPSn), dipropyl polysulfides (DPSn), dimethyl thiosulfinate (TiM2) and allicin (TiA2) are predominant in the extract of garlic.

16. The composition as claimed in claim 14, characterized in that the sulfur-containing compounds consisting of diallyl polysulfides (DASn), dimethyl disulfide (DMS2), dipropyl disulfide (DPS2), dimethyl thiosulfinate (TiM2) and allicin (TiA2) are predominant in the extract of garlic.

17. The composition as claimed in claim 14, characterized in that the DASn represent more than 50% of the sulfur-containing compounds of the extract of garlic.

18. The composition as claimed in claim 14, characterized in that it contains allicin.

19. The composition as claimed in claim 14, characterized in that it contains alliin.
